(19) United States
(12) Patent Application Publication
(10) Pub. No.: US 2022/0180855 A1
(43) Pub. Date: Jun. 9, 2022

(54) SHOCK WAVE GENERATOR DEVICES AND SYSTEMS

(71) Applicant: Igor Fridman, Netanya (IL)

(72) Inventor: Igor Fridman, Netanya (IL)

(21) Appl. No.: 17/114,688

(22) Filed: Dec. 8, 2020

(51) Int. Cl. G10K 15/04

(52) U.S. Cl. CPC G10K 15/043

(57) ABSTRACT

Provided are shock wave generator devices and systems having means for improved control of the combustion and detonation in the combustion chamber to result in improved accuracy and longer distance of efficiency. Further provided are shock wave generators having multi-barrels.

### FIELD OF THE INVENTION

The present invention relates to shock wave generators. More particularly, the present invention relates to a shock wave generator that is provided with means for improved control of combustion and detonation in the combustion chamber, as well as to shock generators having multiple barrels.

### BACKGROUND OF THE INVENTION

A shock wave (shockwave) is a propagating disturbance that can move faster than the speed of sound in a medium in which it propagates. A shock wave carries energy and can propagate through a medium and is characterized by an abrupt, change in pressure, temperature, and density of the medium.

Shock waves are applicable in various settings, such as, for example, bird strike control, generally utilized in a bird dispersal device, which provides a means of dispersing bird nuisance. Birds in general pose serious problem in several areas of society, airports, fish ponds, agriculture field etc.

Shock waves are efficient in many various cases where other dispersal methods and devices, such as noise cannon or light generator or varies kinds of scarecrow, are not useful.

Shock waves are generated by suitable shock wave generator systems, such as, for example, a generator disclosed in U.S. Pat. No. 5,430,691, entitled “Shock Wave Generator”. This two-phase wave generator includes a combustion chamber that includes a first combustion portion having an input port and a second detonation portion, positioned downstream from the first portion, having an output aperture.

The main drawback of shock wave generators known in the art, is in lack of stability in the wave front. There are disturbances and changes in the pressure of the wave front due to detonation breakdown, while the wave is propagating from one portion of the combustion chamber to the other portion, to thereby lose pressure and stability.

There is thus a need in the art to have an improved control of the detonation and combustion of the flame front and shock wave, while it propagates in the combustion chamber, and to prevent or at least ameliorate changes in the direction of the propagating shock wave, in order to establish a reliable, cost-efficient, safe and effective shock wave generating system.

### SUMMARY OF THE INVENTION

According to some embodiments, there are provided improved shock wave generator devices and systems and uses thereof. In some embodiments, the disclosed devices and systems are advantageous, as they can allow control over the delay, velocity and/or peak pressure of the shockwaves to result in a more reliable system that can produce stronger shock wave having higher accuracy in propagation and direction. The disclosed systems and devices are further advantageous as they are cost effective by dramatically reducing the amount of combustion fluid needed to produce an effective shockwave and can further advantageously use smaller size generators to achieve an effective desired shockwave.

In some embodiments, it is an object of the present invention to provide a shock wave generator that is safer than currently used generators.

In some embodiments, an object of the present invention is to provide a shock wave generator device that has a stabilized wave front.

According to some embodiments, an additional object of the present invention to provide a shock wave generator device that can maintain a stable and controlled propagation of the shock wave by utilizing an advantageous turbulence stimulator in the combustion chamber, wherein the turbulence stimulator includes three distinct portions (phases).

According to some embodiments, it is yet another object of the present invention to provide a shock wave generator device having an increasing outlet diameter of combustion chamber for achieving a longer distance of efficiency.

According to some embodiments, it is yet another object of the present invention to provide a shock wave generator having a multi-barrel combustion chamber that can provide more power and longer distance of efficiency, and produce a synchronized shock wave, as further detailed below.

According to some embodiments, there is provided a shock wave generator, configured to generate a shock wave, said generator includes:
a supply line having a nozzle, said supply line is configured to receive a combustive fluid;
an igniter provided in said supply line, said igniter is configured to initiate a flame front and cause detonation in a combustion chamber;
wherein the combustion chamber is associated with said nozzle, and is configured to receive said combustive fluid from said nozzle, said combustion chamber includes: an aperture opposite said nozzle, and turbulence stimulator unit, said turbulence stimulator unit comprises a pole located along the internal cavity of said combustion chamber, said pole is provided with a plurality of lateral protrusion units configured to encounter the flame front, wherein said plurality of lateral protrusion units are arranged on said pole in at least three portions, wherein the first portion is adjacent said nozzle and wherein each consequent portion is provided with protrusion units comprising additional encountering protrusion elements compared to the number of encountering protrusion elements in the respective protrusion units in a former portion;
whereby, a periodically initiated flame front generated detonation is controlled by said plurality of lateral protrusion units, and is propagating from said nozzle to said aperture.

According to some embodiments, the combustion chamber may be tube-like shaped, and wherein said combustion chamber comprises a convex close end. In some embodiments, the convex close end has a curvature substantially similar to the curvature of the flame front.

According to some embodiments, the generator may be configured to generate a controlled shock wave front and/or to control the velocity of a flame propagation in the combustion chamber

According to some embodiments, the lateral protrusion units in the first portion include a plurality of protrusion elements, attached along said pole. In some embodiments, the protrusion elements include two opposite arms. In some embodiments, each of the consequent protrusion units is turned in a predetermined angle in respect with a consequent unit. According to some embodiments, each protruding unit may be at an angle of about 25° with respect of a consequent protruding unit in the first portion.

According to some embodiments, the lateral protrusion units in a second portion of said pole comprises a plurality of protrusion elements attached along said pole, the protrusion elements comprise arms. According to some embodiments, the arms may be arranged in consequent sets of three arms attached about said pole, and wherein each arm in the sets is substantially at an angle of about 120° from the other arm in the set. According to some embodiments, each of the consequent protruding units may be turned in a predetermined angle in respect with a consequent unit.

According to some embodiments, the lateral protrusion units in the third portion of the pole may include a plurality of protrusion elements, attached along said pole, said protrusion elements comprise arms. In some embodiments, the arms are arranged in consequent sets of four arms, attached in a cross shape about said pole. According to some embodiments, each of said consequent protruding units is turned in a predetermined angle in respect to a consequent unit.

According to some embodiments, a set of two consecutive protruding units are not placed in overlapping position around said pole therebetween.

According to some embodiments, the protruding elements of each protruding unit may have similar or different shape, size and/or composition. Each possibility is a separate embodiment.

According to some embodiments, the protruding units in each portion may have a similar or different shape, size and/or composition. Each possibility is a separate embodiment.

According to some embodiments, the protruding units may be attached to, associated with, mounted on or formed with said pole.

According to some embodiments, the arms are substantially flat.

According to some embodiments, the combustion chamber may include an increasing outlet diameter at the aperture end thereof. According to some embodiments, the increased outlet diameter includes an extension having a cone shape, which is connected to or formed with said combustion chamber.

According to some embodiments, the combustive fluid may include a mixture of air and fuel. In some embodiments, the fuel is a flammable or combustible gas.

According to some embodiments, the shock wave generator may further include a mixer, that is configured to receive air from an air line and fuel from a fuel line, wherein said mixer is configured to mix the air and the fuel and provide a resulting mixture of air and fuel to said supply line.

According to some embodiments, the generator may further include a control unit configured to control the mixer and/or igniter, and/or any other operating parameters of the generator.

According to some embodiments, the generator may be used as a non-lethal means for the deterrence of mammals, poultry and/or fish.

According to some embodiments, there is provided a multi-barrel shock wave generator, configured to generate a synchronized controlled wave front, said generator includes:
a supply line having a nozzle, said supply line is configured to receive a combustive fluid;
an igniter provided in said supply line, said igniter is configured to initiate a flame front and cause detonation in a combustion chamber;
wherein the combustion chamber is associated with said nozzle, and is configured to receive said combustive fluid from said nozzle, said combustion chamber includes: an aperture opposite said nozzle, and turbulence stimulator unit, said turbulence stimulator unit comprises a pole located along the internal cavity of said combustion chamber, said pole is provided with a plurality of lateral protrusion units configured to encounter the flame front, wherein said plurality of lateral protrusion units are arranged on said pole in at least three portions, wherein the first portion is adjacent said nozzle and wherein each consequent portion is provided with protrusion units comprising additional encountering protrusion elements compared to the number of encountering protrusion elements in the respective protrusion units in a former portion; and
two or more exit barrels, associated with the aperture of the combustion chamber;
whereby, a periodically initiated flame front generated detonation is controlled by said plurality of lateral protrusion units, and is propagating from said nozzle to said aperture, to synchronically propagate and exit thought the exit barrels.

According to some embodiments, the lateral protrusion units in the first portion may include two protrusion elements, attached along said pole.

According to some embodiments, the lateral protrusion units in a second portion of said pole comprises a plurality of protrusion elements attached along said pole, the protrusion elements may include three arms, and wherein each arm in the unit is substantially at an angle of about 120° from the other arm in the unit.

According to some embodiments, lateral protrusion units in the third portion of the pole may include a plurality of protrusion elements, attached or mounted along said pole, said protrusion elements include four arms, arranged in a cross shape about said pole.

According to some embodiments, a set of two consecutive protruding units are not placed in overlapping position around said pole therebetween. According to some embodiments, the protruding elements of each protruding unit may have a similar or different shape, size and/or composition. Each possibility is a separate embodiment.

According to some embodiments, the protruding units in each portion may have a similar or different shape, size and/or composition. Each possibility is a separate embodiment. According to some embodiments, the arms are substantially flat.

According to some embodiments, the protruding units may be attached to, associated with, mounted on or formed with said pole. Each possibility is a separate embodiment.

According to some embodiments, each of the exit barrels may have an increasing outlet diameter at the exit end thereof.

According to some embodiments, the shock wave generator may further include a mixer, configured to receive air from an air line and fuel from a fuel line, wherein said mixer is configured to mix the air and the fuel and provide a resulting mixture of air and fuel to said supply line.

According to some embodiments, each of the exit barrels may include a turbulence stimulator comprising protruding units having comprising a plurality of protrusion elements, mounted along a pole, said protrusion elements comprise four arms.

According to some embodiments, the shock wave generator may further include a control unit configured to control the mixer and/or igniter, and/or any other operating parameters of the generator.

According to some embodiments, the multi-barrel generator may further include a control unit configured to control the mixer and/or igniter.

According to some embodiments, the multi-barrel generator may be used as a non-lethal means for the deterrence of mammals, poultry and/or fish.

According to some embodiments, there is provide a method of generating a shock wave, said method includes one or more of the steps of:
providing a shock wave generator which includes:
   a supply line having a nozzle, said supply line is configured to receive a combustive fluid;
   an igniter provided in said supply line, said igniter is configured to initiate a flame front and cause detonation in a combustion chamber; wherein the combustion chamber is associated with said nozzle, and is configured to receive said combustive fluid from said nozzle, said combustion chamber includes: an aperture opposite said nozzle, and turbulence stimulator unit, said turbulence stimulator unit comprises a pole located along the internal cavity of said combustion chamber, said pole is provided with a plurality of lateral protrusion units configured to encounter the flame front, wherein said plurality of lateral protrusion units are arranged on said pole in at least three portions, wherein the first portion is adjacent said nozzle and wherein each consequent portion is provided with protrusion units comprising additional encountering protrusion elements compared to the number of encountering protrusion elements in the respective protrusion units in a former portion;
   providing combustive fluid through said supply line to said combustion chamber;
   ignite said combustive fluid using said igniter.

According to some embodiments, there is provided a method of generating a synchronized shock wave, using a multi-barrel shock wave generator, the method includes one or more of the steps of:

providing a multi-barrel shock wave generator which includes:
a supply line having a nozzle, said supply line is configured to receive a combustive fluid;
an igniter provided in said supply line, said igniter is configured to initiate a flame front and cause detonation in a combustion chamber; wherein the combustion chamber is associated with said nozzle, and is configured to receive said combustive fluid from said nozzle, said combustion chamber includes: an aperture opposite said nozzle, and turbulence stimulator unit, said turbulence stimulator unit comprises a pole located along the internal cavity of said combustion chamber, said pole is provided with a plurality of lateral protrusion units configured to encounter the flame front, wherein said plurality of lateral protrusion units are arranged on said pole in at least three portions, wherein the first portion is adjacent said nozzle and wherein each consequent portion is provided with protrusion units comprising additional encountering protrusion elements compared to the number of encountering protrusion elements in the respective protrusion units in a former portion; and

two or more exit barrels, associated with the aperture of the combustion chamber;

providing combustive fluid through said supply line to said combustion chamber; and
igniting said combustive fluid using said igniter.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE DRAWINGS

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not to scale.

FIG. 1 A schematic illustration of a shock wave generator system, according to some embodiments;

FIG. 2A—a schematic illustration of a longitudinal cross section of a combustion chamber with turbulence stimulator, according to some embodiments;

FIG. 2B—a schematic illustration of a perspective view of a turbulence stimulator, according to some embodiments;

FIG. 2C—a schematic 2D, side view of a turbulence stimulator having three portions, according to some embodiments;

FIGS. 3A-C—schematic illustrations of perspective views of protruding units, according to some embodiments; FIG. 3A—protruding units located in a first portion (region) of a turbulence stimulator; FIG. 3B—protruding units located in a second portion (region) of a turbulence stimulator; FIG. 3C—protruding units located in a first portion (region) of a turbulence stimulator;

FIGS. 4A-4B—schematic illustration of multi-barrel shock wave generator devices, according to some embodiments. FIG. 4A—a multi-barrel having three barrels; FIG. 4B—a multi-barrel having five barrels;

FIGS. 5A-B—schematic illustrations of end extension of barrels of a shock wave generator, according to some embodiments.

FIGS. 6A-C—line graphs showing pressure (Atm) of shock wave generated by various shock wave generators, at a 10 m distance. FIG. 6A—shock wave generated by a shock wave generator having combustion chamber with a turbulence stimulator, according to some embodiments; FIG. 6B—shock wave generated by a shock wave generator having combustion chamber having an extended diameter at the end thereof, according to some embodiments; and FIG. 6C—shock wave generated by a multi-barrel shock wave generator.

### DETAILED DESCRIPTION OF THE INVENTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention.

According to some embodiments there are provided shock wave generator devices and systems for producing a controllable shockwave, and uses thereof. In some embodiments, the shock wave generator includes an advantageous turbulence stimulator, located within a combustion chamber, wherein the turbulence stimulator includes protruding units, situated in at least three distinct portions (regions) along the turbulence stimulator, to allow controlling the combustion and shock wave propagation thought the combustion chamber. In further embodiments, the advantageous shock wave generator devices and systems disclosed herein include a multi-barrel shock wave generator, comprising more than one barrel. In some embodiments, the barrel may include one or more internal obstructers (protruding units and protruding elements), located along the internal cavity/volume of of the barrel. In some embodiments, the devices may further include barrels with changing diameter at their end, such that the diameter of the barrel can change along its length, in particular at the exit region of the barrel.

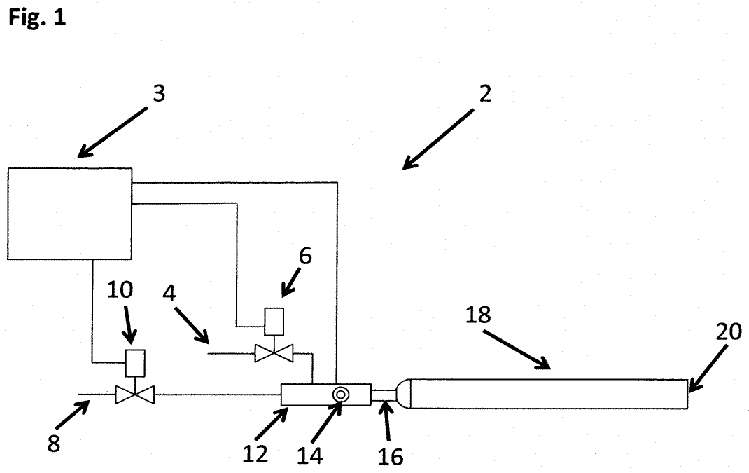

Reference is now made to FIG. 1, which schematically illustrates a shock wave generator system, according to some embodiments. As shown in FIG. 1, shock wave generator 2, includes a control unit (3), fuel/gas supply line (4), having a control valve ((6), for example, a solenoid control valve)), air supply line (8), having a control valve ((10), for example, a solenoid control valve)), a mixer (12), an ignition region (14), associated with nozzle (16) of barrel (combustion chamber), 18. The control unit is configured to control the air supply valve and gas supply valve, to allow mixing thereof in the mixer region, and to further allow ignition of said air-fuel mixture, to initiate a detonation, which propagates via the nozzle, thought the barrel, to result in shock wave exiting the end of the barrel, at the aperture side (20), thereof.

In some exemplary embodiments, fuel, for example, in the form of a combustible fuel (such as gas) and air are compressed through their respective supply lines, when their respective control valves, which are controlled by the control unit, are opened. The air and fuel are compressed into the mixer at suitable pressures so as to provide, at the output of the mixer, a suitable air-fuel mixture having a preselected fuel to air ratio. Under the control of the control unit, the igniter (for example, in the form of a spark plug) can be activated to result in detonation. In some embodiments, the ignition occurs after the mixture of fuel and air has filled the barrel (combustion chamber). Upon activation of the igniter, combustion is established in the combustion chamber. The combustion shock wave, which starts at the nozzle, propagates through the barrel, and released through the aperture (situated at the opposite side of the nozzle).

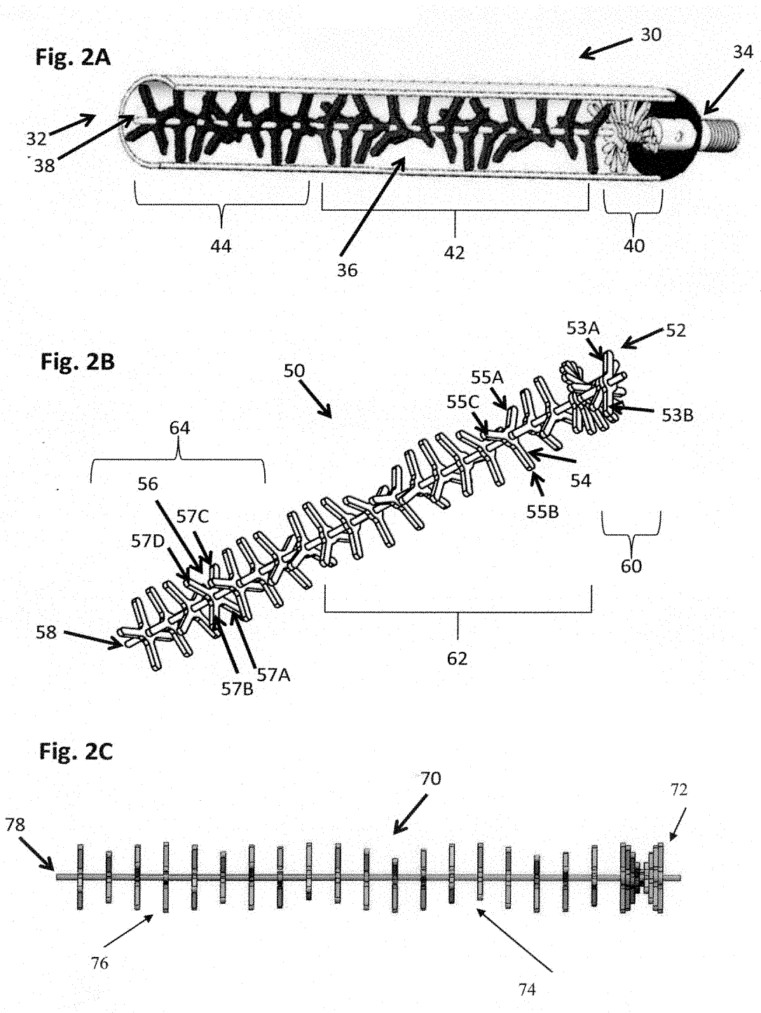

According to some embodiments, the barrel (also referred to herein as combustion chamber), is an elongated tube-like housing, having an internal cavity, through which the burning front and waves can propagate, from the nozzle (initiation side, deflagration side) to the exit (aperture side). In some embodiments, the combustion chamber includes within the internal cavity thereof a turbulence stimulator unit, configured to stabilize, enhance and/or expedite combustion of the air-fuel mixture in a controlled manner, to result in the controlled generation of shock waves. Reference is now made to FIG. 2A, which illustrates a longitudinal cross section of a combustion chamber with turbulence stimulator, according to some embodiments. As shown in FIG. 2A, the turbulence chamber (30) has an aperture end (32) and a nozzle (34) on the opposite side. Further shown is turbulence stimulator unit (36), which includes a pole axis (38), and a plurality of protrusion units, located/placed/situated/formed with or around pole (38). The protrusion units are divided along the pole in at least three distinct portions, a first portion (phase) (40), which is closer to the nozzle region, a consequent, second portion (phase) (42), and a third portion (phase) (44), which is closer to the aperture side of the combustion chamber. The number, distribution and/or shape of the protrusion units between the various portions of the stimulator are different, as detailed below herein.

According to some embodiments, the fuel may be any suitable flammable or combustible gas, including, for example, but not limited to: methane (CH₄) ethylene, propane, propane-butane, hydrogen, and the like. Each possibility is a separate embodiment.

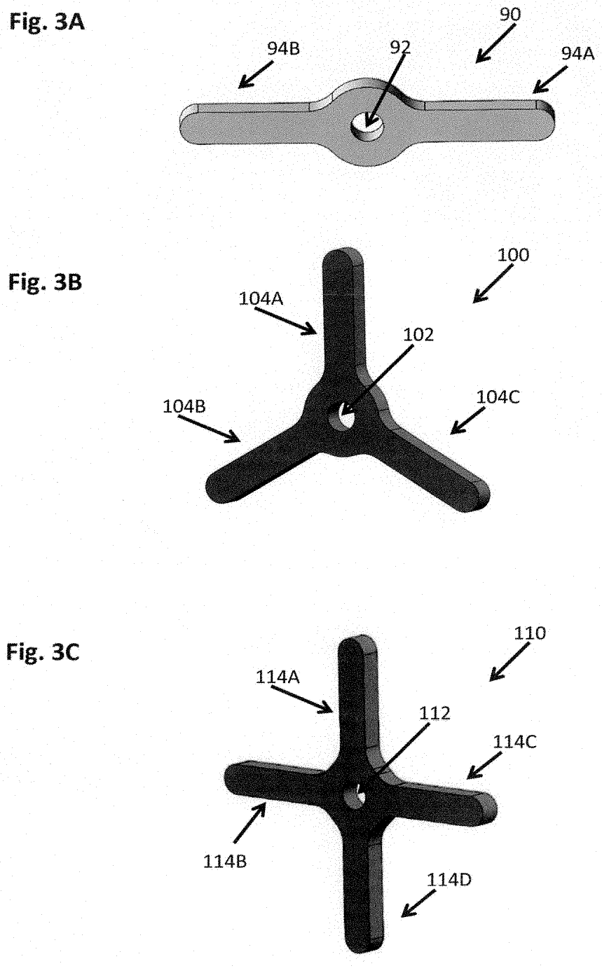

Reference is now made to FIG. 2B, illustrating perspective view of a turbulence stimulator, according to some embodiments. As shown in FIG. 2B, turbulence stimulator (50), includes a plurality of protrusion units, shown as representative, exemplary units, 52, 54 and 56. The protrusion units are mounted, located, placed, situated, organized, formed about or formed with and along a central pole (58). The protrusion units are each made of protrusion elements (encountering protrusion elements), such as, rods or arms, that protrude outwardly from the pole and preferably, perpendicular with respect to the pole. The protruding units are configured to encounter the flame front of the shock wave and act as a turbulator to the flow of the shock wave. In some embodiments, the protruding units enhance the combustion and detonation as well as control them. The various protruding units are arranged along the pole in at least three distinct portion (phases). The first portion (60) is closer to the nozzle end of a combustion chamber (i.e., closer to the deflagration/ignition region). The second portion (62) is consequent to the first portion (in the direction away from the nozzle side). The third portion (64) is consequent to the second portion and is closer to the exit (aperture) side, from which the shock waved exit the combustion chamber. The number of the encountering protruding elements in each of the protruding units in the third portion are higher than the corresponding number of encountering protruding elements in the second portion. Likewise, the number of the encountering protruding elements in each of the protruding units in the second portion are higher than the corresponding number of encountering protruding elements in the first portion. Shown in FIG. 2B are protruding elements 53A-B, of protruding unit 52. Shown in FIG. 2B are protruding elements 55A-C, of protruding unit 54. Shown in FIG. 3B are protruding elements 57A-D, of protruding unit 56. As further shown in FIG. 2B, the distribution (density and/or number) of the protruding units within each portion may be different between the various portions. Further, as shown in FIG. 2B, each of the consequent protrusion units may be placed in an angle relative to each other. In some embodiments, consequent protrusion units are not situated on the pole, such that they overlap therebetween.

According to some embodiments, the distribution, number, density and/or relative angle positioning of the protrusion units along the pole, is advantageous, as it allows a control of the shock wave.

In some exemplary embodiments, the first portion of the pole is adjacent to the nozzle in order to establish an efficient deflagration (i.e., subsonic combustion propagating through heat transfer) or scattering or increasing the volume of the flame front to thereby increase the velocity of combustion.

In some embodiments, the first portion of the turbulence stimulator includes protruding units, each having two protruding elements (arms), which may be arranged symmetrically around a center. In some embodiments, the arms may be arranged at an angle of about 180 degrees to each other (i.e. opposite one another).

In some embodiments, the second portion of the turbulence stimulator includes protruding units, each having three protruding elements (arms), which may be arranged symmetrically around a center. In some embodiments, the arms may be arranged at an angle of about 120 degrees to each other.

In some embodiments, the protrusion unit elements in the third portion each include four arms (protrusion elements) which may be arranged as a cross. The crosses can direct the flow of the shock wave towards the aperture of the combustion chamber and uphold detonation. Another function of the crosses is to maintain a flame front. In some embodiments, the arms may be arranged at an angle of about 120 degrees to each other.

According to some embodiments, the gradual increase in the number of arms (elements) in each consequent set, between the portions of the turbulence stimulator, facilitates a stable flame front that is propagating from nozzle to aperture. The arrangement of the consequent protruding elements, in respect to one another is preferably not in parallel. In the third portion, for example, each consequent protruding unit is turned about the pole (axis) by a certain angle, preferably 25°, in respect with the former protruding unit. The preferred arrangement of the protruding units is according to the advancement of the detonation, which propagates in helical path. In some embodiments, the purpose of the protruding units arrangement is to avoid disturbances to the detonation core (spin) trajectory.

Reference is now made to FIG. 2C, which shows a schematic 2D, side view of a turbulence stimulator, according to some embodiments. As shown in FIG. 2C, turbulence stimulator, 70, includes various protruding elements, arranged in three distinct portions: a first portion (72), a second portion (74) and a third portion (76), along a central pole (78). In the first portion, the burning process is initiated and enters the combustion chamber. The protruding units in the first section are configured to break and/or scatter the flame front (due to the collisions with the protruding units), and to increase the pressure in the combustion chamber. Approximately at the middle of the second portion, the detonation process occurs (i.e., Deflagration-Detonation Transition (DTT)). Consequently, because of the protruding units in the third portion, the pressure of the shock waves is increased when exiting the barrel, via the aperture of the combustion chamber. This results in improved shock wave generators, which utilize smaller (diameter and/or length) barrels, which are consequently also more energy efficient.

Reference is now made to FIGS. 3A-C, which schematically illustrate perspective views of protruding units, according to some embodiments. Shown in FIG. 3A is a schematic view of protruding unit, 90, having a center (92) and two protruding elements (arms 94A-B). The protruding unit shown in FIG. 3A is configured to be located in the first portion of a turbulence stimulator, as detailed above. As shown in FIG. 3A, the two arms are substantially arranged around a center (configured to fit on a center pole of a turbulence stimulator). The arms oppose each other, substantially at 180 degrees.

Reference is now made to FIG. 3B, which is a schematic view of protruding unit, 100, having a center (102) and three protruding elements (arms 104A-C). The protruding unit shown in FIG. 3B is configured to be located in the second portion of a turbulence stimulator, as detailed above. As shown in FIG. 3B, the three arms are substantially arranged symmetrically around a center (configured to fit on a center pole of a turbulence stimulator). The arms may at an angle of about 120 degrees to each other.

Reference is now made to FIG. 3C, which is a schematic view of protruding unit, 110, having a center (112) and four protruding elements (arms 114A-D). The protruding unit shown in FIG. 3C is configured to be located in the third portion of a turbulence stimulator, as detailed above. As shown in FIG. 3C, the four arms are substantially arranged symmetrically around a center (configured to fit on a center pole of a turbulence stimulator). The arms may at an angle of about 90 degrees to each other.

In some embodiments, the arms are flat. In some embodiments, the arms may be composed of: metal, plastic, or any other suitable material having the required physical and chemical properties to withstand heat and pressure.

In some embodiments, by utilizing substantially flat arms in the protruding units, the contact area between the wave and the arms is increased.

In some embodiments, the arms of the protruding units do not touch the internal walls of the combustion chamber.

In some embodiments, the pole is made of metal, plastic or any other suitable material having the required physical and chemical properties to withstand heat and pressure. In some embodiments, the pole is solid. In some embodiments, the pole is not perforated. In some embodiments, the diameter of the pole is proportional to the diameter of the barrel. In some embodiments, the length of the pole is proportional or corresponds to the length of the combustion chamber.

In some embodiments, the various protrusion units may be mounted, fixed located, placed, situated, organized, formed about and/or attached to the pole, along the length thereof. Each possibility is a separate embodiment. In some embodiments, the various protrusion units may be formed with and along the pole. Each possibility is a separate embodiment. In some embodiments, the various protrusion units are reversibly affixed to the pole.

According to some embodiments, the placing/location of the protruding units (obstructers) conform with the trajectory of the core of detonation (spin), i.e. they should not hinder from the propagation of detonation and should not brake the detonation. The trajectory of spin detonation is spiral with step πD, D-being diameter of the barrel. Thus, the protruding units, in addition to having a specific hydraulic resistance, the ends thereof are placed spirally with step πD, along the entire length of the combustion chamber, along the pole.

In some embodiments, the disclosed turbulence stimulator can be used to provide combustion chambers (barrels), which are shorter, while exhibiting at least as good of shock wave generating as compared to corresponding generators having longer barrels, without the turbulence stimulator or a barrel having a two phase turbulence stimulator.

According to some embodiments, since the velocity of the shockwave changes according to the distance covered over time, the configuration of the protruding units (i.e. type, size, position, location and/or distribution), allows controlling (increasing or decreasing) the velocity of the shockwaves.

According to some embodiments, by changing the relation between the length of the barrel and the configuration of the protruding units, a control over the delay, peak pressure and over pressure of the shockwaves can be achieved.

According to some embodiments, the closed end of the combustion chamber, through which air-fuel supply line passes is convex and shaped as a part of a sphere that protrudes outwardly from the chamber itself. As mentioned above, the flame front (initiation) propagates from the nozzle towards the aperture of the combustion chamber. Part of the flame front can propagate towards the closed end, and collide into it. The collision originates a reflected wave that also propagates also towards the aperture. Since the closed end has preferably a curvature, that conforms to the curvature of the front of the shock wave, the shock wave front can collide with any point of the close end at the same time. Therefore, the reflected wave has the same curvature of the original wave front and when it propagates towards the aperture and collides with rare waves, it discharges the waves substantially completely by adsorbing their energy, so that the combustion chamber is ready for another new pulse of shock wave. In the shock wave generator of the present invention, the discharge of the rare waves is substantially completed so that the generator is ready for the consequent wave front (pulse) when there is minimal interferences in the combustion chamber, if any, and the operation of the shock wave generator is optimized.

According to some embodiments, there are further provided multi-barrel shock wave generators. In some embodiments, the multi-barrels generator can include a common detonation section (combustion chamber) for performing the detonation and thereafter, the shock wave pressure is maintained in each exit barrel (i.e., the barrels from which the shock waves exit to the environment). In some embodiments, the common section/barrel of the multi-barrels includes a turbulence stimulator as disclosed herein. In some embodiments, the protruding units of a turbulence generator, which are placed along the internal region of the barrel, allow maintaining the shock wave pressure In some embodiments, the configuration of the protruding units allows breaking the detonation in the junction point in which the multi-barrel connect.

According to some embodiments, the placing/location of the protruding units should conform with the trajectory of the core of detonation (spin) i.e. they should not hinder from the propagation of detonation and should not brake the detonation. The trajectory of spin detonation is spiral with step πD, D-being diameter of the barrel. Thus, the protruding units, aside from having a specific hydraulic resistance, the ends thereof should be placed on spiral with step πD, along the entire length of the chamber.

According to some embodiments, when the shockwaves reach the edge (end) of the multi-barrels, each having the same parameters, the pressure of the generated shock waves can add up. In some embodiments, the exit barrels may similar or identical in shape, size, diameter, and/or composition. Each possibility is a separate embodiment. In some embodiments, at least some of the exit barrels in a multi-barrel shock wave generator may be similar or identical in shape, size, diameter, and/or composition. Each possibility is a separate embodiment.

According to some embodiments, by changing the relation/ratios between the lengths of the barrels and configuration of the protruding units, a control over the delay, peak pressure and over pressure of the shockwaves can be achieved.

According to some embodiments, the disclosed three-phase turbulence stimulator is configured to provide detonation stability in the common section of the detonation of the multi-barrel, by making this common section shorter. In some embodiments, the common barrel includes a three portion (phase) turbulence stimulator as disclosed herein, such that the third portion ends in the common section (connection region) of the exit barrels. In some embodiments, each of the exit barrel include within their internal cavity (region) a turbulence stimulator having protruding units of the third portion (i.e., for example, protruding units having four arms), to maintain the pressure in the exit barrel. In some embodiments, the exit barrels may have a turbulence stimulator having at least protruding units of the third portion, with each section of the barrel (for example, with barrels having a non-straight cavity composed of two sections).

According to some embodiments, since the velocity of the shockwave changes according to the distance covered over time, the configuration of the protruding units, allows increasing or decreasing the velocity of the generated shockwaves.

According to some embodiments, when the shockwaves reach the edge (end) of the multi-barrels with the same parameters, the pressure of the generated shock waves can add up to a synchronized, coherent shock wave.

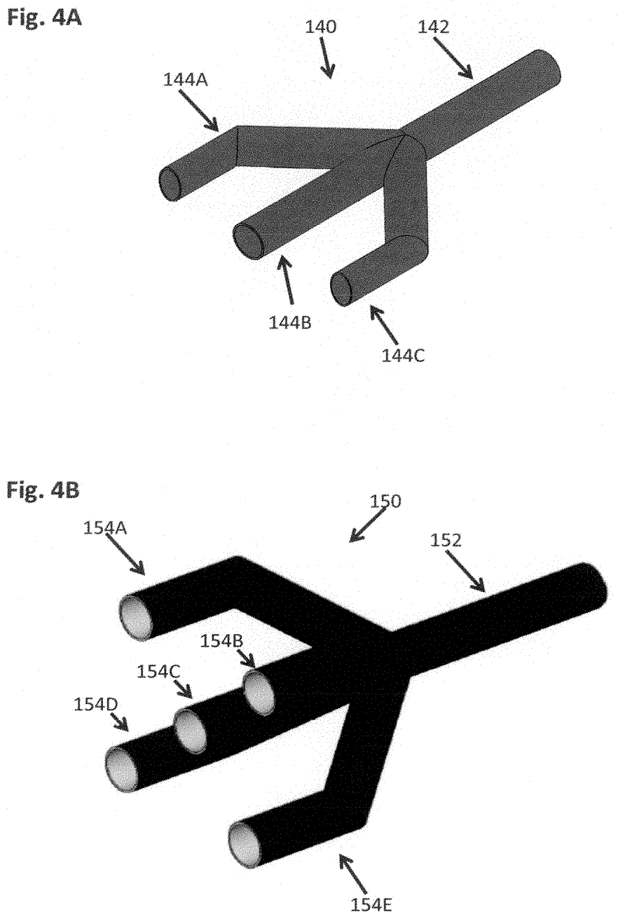

Reference is now made to FIGS. 4A-4B, which schematically illustrate multi-barrel shock wave generator devices, according to some embodiments. As shown in FIG. 4A, multi-barrel, 140, includes a common combustion chamber (142), and three barrels (shown as barrels 144A-C), interconnected, said barrels are configured to release the shock wave, preferentially, in synchronization, and/or to produce a coherent shock wave. In some embodiments, the barrels may have a straight cavity (such as barrel, 144B), or may have barrel(s) made of at least two cavities (such as in barrels, 144A, 144C), that may be at an angle (such as, for example, 25 degrees) relative to each other. In some embodiments, each cavity of the exit barrel may include a turbulence stimulator, having protruding units of the third portion. Shown in FIG. 4B is a multi-barrel, 150, having a common combustion chamber, 152 and five separate exit barrels (shown as barrels 154A-E). In some embodiments, the barrels may have a straight cavity (such as barrel, 154C), or may have barrel(s) made of at least two cavities (such as in barrels, 154A-B, and 154D-E), that may be at an angle (such as, for example, 25 degrees) relative to each other. In some embodiments, each cavity of the exit barrel may include a turbulence stimulator, having protruding units of the third portion. The barrels connect at a common region, and are configured to release/disperse/exit the shock wave, preferably in synchronization and/or to produce a coherent shock wave.

In some embodiments, the multi-barrel shock wave generators include a turbulence stimulator, as disclosed herein, at least in the common combustion chamber. Optionally, one or more of the exit barrels also include a turbulence stimulator. In some embodiments, the turbulence stimulator in the exit barrels may include one type of protruding units, for example, protruding units of the third portion of the three phase turbulence stimulator. In some embodiments, if the exit barrel is sectioned (i.e., not having a straight barrel, but rather having junction points/regions), each of the sections may have a separate turbulence stimulator, which may include one type of protruding units, for example, protruding units of the third portion of the three phase turbulence stimulator.

According to some embodiments, when tested (as further exemplified herein below), a shock wave generator with a configuration of 3 barrels or 5 barrels show that in a distance of 5 and 10 meters from the edge of the generator, one pulse is detected (registered), as a result of cognitively addition of the waves.

According to some embodiments, in order to improve the control over the pressure impulse, the diameter of the output of the barrel may be changed. When an explosion occurs, the propagation of shock waves is a function of source size. However, when the shockwaves are passed from one diameter to a different diameter, the pressure and velocity are changed. In order to keep or increase the shockwave's parameters, the angle of shockwaves beam should be no more than 15 degrees after changing of diameter of barrel. Thus, in accordance with some embodiments, the various barrels disclosed herein may optionally include, at their opening (aperture) an extension, allowing an increase in the diameter of exit, to thereby improve the control over the shock wave. The extension may be in the form of a cone or semi-cone and may be attached/connected to the existing barrel by various means, such as, for example, welding, using connecting elements, such as screws, or other fitting means. In some embodiments, the extension may be formed as an integral part of the barrel. In some embodiments, the extension may form a continuous passage of waves with the barrel.

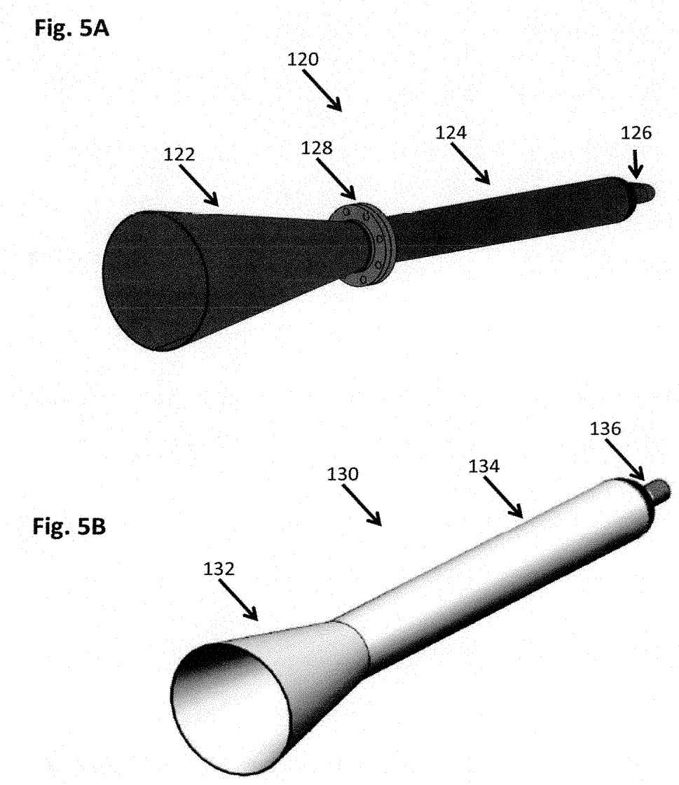

Reference is now made to FIGS. 5A-B, which schematically illustrate barrel extensions located at the exit end of the barrel, to increase the diameter thereof, in accordance with some embodiments. As shown in FIG. 5A, barrel, 120, includes a nozzle end (126), combustion chamber (124) and extension (122), shown as conical extension end. Further shown is connecting means (128), allowing the connecting of the extension to the barrel. The connection between the barrel and the extension is preferably sealed and secured. As shown in FIG. 5B, barrel, 130, includes a nozzle end (136), combustion chamber (134) and extension (132), shown as conical extension end, which is formed as an integral part of the barrel.

According to some embodiments, combination of the three-phase turbulence stimulator with increasing the diameter of outlet of shockwave generator can allow increasing the effective distance of the shockwave generator.

According to some embodiments, the devices and systems disclosed herein can be used as a controllable shockwave generator that can be used in various settings, including, but not limited to: a non-lethal weapon for the deterrence of birds and animals in airport areas, agriculture fields and fishponds, as well as for other applications, including cleaning of machinery and the like. In some embodiments, the disclosed shock wave generators can be used as non-lethal means for deterrence of various organisms.

In some embodiments, there is provided a shock wave generator for use in a method of deterrence of various animals, including, mammals, poultry and/or fish.

In some embodiments, there is provided a multi-barrel shock wave generator for use in a method of deterrence of various animals, including, mammals, poultry and/or fish.

According to some embodiments, there is provided a wave shock generator that is safer than available generators, and can be applied in various settings, including cleaning machinery.

According to some embodiments, there is provided a wave shock generator that has a stabilized wave front.

According to some embodiments, there is provided a shock wave generator, configured to generate a controlled shock wave and/or controlling the velocity of flame propagation in a combustion chamber.

According to some embodiments, there is provided a wave shock generator that maintains a stable and controlled propagation of the shock wave by reducing gradually the turbulators in the combustion chamber.

In some embodiments, there is provided an advantageous three-phase turbulence stimulator (turbulence generator, turbulence creator), which includes protruding units, displaced along the length of the stimulator, in at least three distinct phases (regions, portions), such that the number of the protruding elements in the protruding units of each phase is reduced, as the portion is closer to the ignition (nozzle end), or is increased as the portion is closer to the aperture end. In some embodiments, the advantageous placement of the protruding units, their distribution, density and/or number, along the stimulator allows controlling the shock wave propagation.

According to some embodiments, there is provided a turbulence stimulator unit which includes a pole (located, placed along an internal cavity of a combustion chamber), said pole is provided with a plurality of lateral protrusion units configured to encounter a flame front, wherein the plurality of lateral protrusion units are arranged on said pole in at least three portions, wherein the first portion is adjacent a nozzle of the chamber and wherein each consequent portion is provided with protrusion units comprising additional encountering protrusion elements compared to the number of encountering protrusion elements in the respective protrusion units in a former portion.

According to some embodiments, there is provided a method of generating a wave shock, the method includes utilizing the combustion chambers disclosed herein, which include a turbulence stimulator having at least three portions and optionally, an extended output diameter. In some embodiments, there is provided a method of generating a wave shock using a multi-barrel shock wave generators.

According to some embodiments, the shockwave generators disclosed herein are portable. In some embodiments, the shock wave generators disclosed herein are configured to be mounted on a suitable carrier, such as, a vehicle. In some embodiments, the generator may be mounted to fixed to a vehicle and the control unit thereof may be located in a remote location, to allow operating of the generator from a distance.

The terms “wave shock generator”, “shock wave generator” and “shockwave generator” may interchangeably be used.

The terms “shock wave” and “shockwave” may interchangeably be used.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although steps of methods according to some embodiments may be described in a specific sequence, methods of the disclosure may include some or all of the described steps carried out in a different order. A method of the disclosure may include a few of the steps described or all of the steps described. No particular step in a disclosed method is to be considered an essential step of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

### EXAMPLES

### Example 1: Detecting Shock Waves Generated Using Various Shock Wave Generators

In order to compare the shock wave parameters generated by various shock wave generators, a high resolution ICP® pressure sensor Model: 102A07 (PCB Piezotronics company) is used. The combustible gas used was Ethylene.

The sensor of the measuring device was placed at a designated distance (10 meters) from the tested shock wave generators and the voltage attributed to the pressure produced by the shock waves is measured. Based on the measurements, various parameters attributed to the shock wave (such as, pressure (measured in atm) and noise (sound pressure level (SPL), measured in dB) are determined/calculated.

Three shock wave generators are tested.
A. a shockwave generator with one barrel including the combustion chamber with the turbulence stimulator disclosed herein.
B. a shockwave generator (as in A) having one barrel and having an extending diameter at its opening (cone extension).
C. A multi-barrel shock wave generator having five barrels.

The shock wave is measured at a distance of 10 meters in an open field.

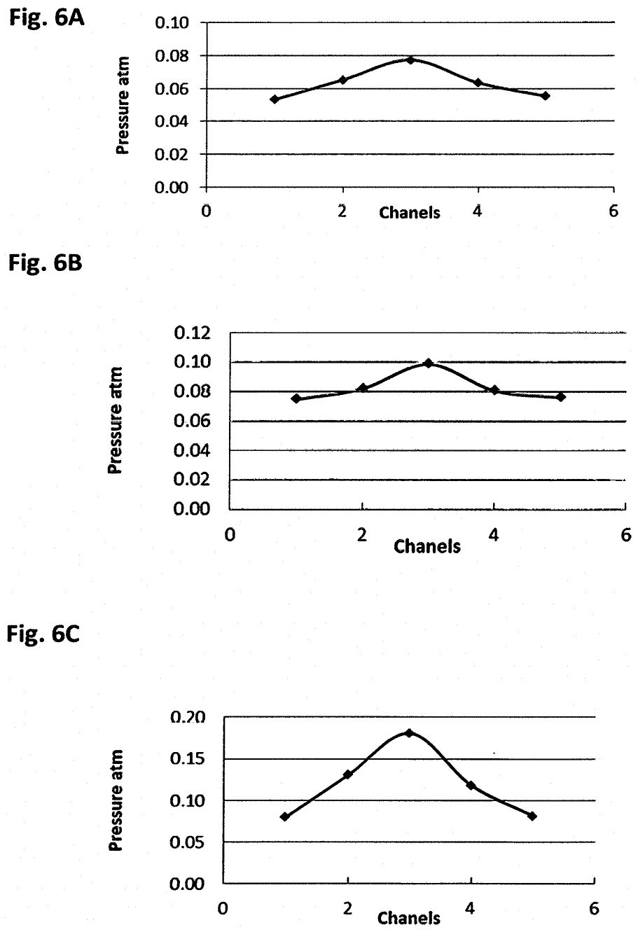

The results are presented in the tables below and in FIGS. 6A-C:
A. A shockwave generator with one barrel. Shown in the graph of FIG. 6A is the pressure of the shock wave generated by the shock wave generator, as measured at 10 m distance from the generator.

TABLE 1

| | Pres. | | SPL |
|---|---|---|---|
| Channel | (atm) | (mv) | (dB) |
| C1 | 0.0533 | 80 | 169 |
| Ch2 | 0.0653 | 98 | 170 |
| Ch3 | 0.0773 | 116 | 172 |
| Ch4 | 0.0633 | 95 | 170 |
| Ch5 | 0.0553 | 83 | 169 |

B. A shockwave generator with one barrel and having an extending diameter at the opening thereof. Shown in the graph in FIG. 6B is the pressure of the shock wave generated by the shock wave generator, as measured at 10 m distance from the generator.

TABLE 2

| | Pres. | | SPL |
|---|---|---|---|
| Channel | (atm) | (mv) | (dB) |
| C1 | 0.0747 | 112 | 172 |
| Ch2 | 0.0820 | 123 | 172 |
| Ch3 | 0.0987 | 148 | 174 |
| Ch4 | 0.0807 | 121 | 172 |
| Ch5 | 0.0760 | 114 | 172 |

C. A multi-barrel shockwave generator with 5 barrels. Shown in the graph in FIG. 6C is the pressure of the shock wave generated by the shock wave generator, as measured at 10 m distance from the shock wave generator.

TABLE 3

| | Pres. | | SPL |
|---|---|---|---|
| Channel | (atm) | (mv) | (dB) |
| C1 | 0.0800 | 120 | 172 |
| Ch2 | 0.1307 | 196 | 176 |
| Ch3 | 0.1807 | 271 | 179 |
| Ch4 | 0.1180 | 177 | 176 |
| Ch5 | 0.0813 | 122 | 172 |

Altogether, the results demonstrate that the advantageous shock wave generators produce an efficient, stable shock wave.

The results further demonstrate that the multi-barrel shock wave generator produces one strong detectable synchronized coherent shock wave (one peak of pressure, and not three peaks, if the shock wave would not synchronize/cohere).

The results further demonstrate the efficiency of increasing the exit diameter of the barrel, as the pressure of the shock wave generated by generator B is stronger than that produced by generator A.

While a number of exemplary aspects and embodiments have been discussed above, those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope.

What is claimed is:

1. A shock wave generator, configured to generate a shock wave, said generator comprising:
a supply line having a nozzle, said supply line is configured to receive a combustive mixer;
an igniter provided in said supply line, said igniter is configured to initiate a flame front and cause detonation in a combustion chamber; wherein the combustion chamber is associated with said nozzle, and is configured to receive said combustive mixer from said nozzle, said combustion chamber comprises:
an aperture opposite said nozzle, and turbulence stimulator unit, said turbulence stimulator unit comprises a pole located along the internal cavity of said combustion chamber, said pole is provided with a plurality of lateral protrusion units configured to encounter the flame front, wherein said plurality of lateral protrusion units are arranged on said pole in at least three portions, wherein the first portion is adjacent said nozzle and wherein each consequent portion is provided with protrusion units comprising additional encountering protrusion elements compared to the number of encountering protrusion elements in the respective protrusion units in a former portion;
whereby, a periodically initiated flame front generated detonation is controlled by said plurality of lateral protrusion units, and is propagating from said nozzle to said aperture.

2. The generator according to claim 1, configured to generate a controlled shock wave front and/or to control the velocity of a flame propagation in the combustion chamber.

3. The generator according to any one of claims 1-2, wherein each of said consequent protrusion units, are turned in a predetermined angle in respect with a consequent unit.

4. The generator according to any one of claims 1-3, wherein each protruding unit is at an angle of about 25° with respect of a consequent protruding unit.

5. The generator according to any one of claims 1-4, wherein said arms are substantially flat.

6. The generator as claimed in claim 5, wherein said protrusion elements comprises two opposite arms in first section.

7. The generator according to claim 5, wherein said arms are arranged in consequent sets of three arms attached about said pole, and wherein each arm in the sets is substantially at an angle of about 120° from the other arm in the set in second section.

8. The generator according to claim 5, wherein said arms are arranged in consequent sets of four arms, attached in a cross shape about said pole in third section.

9. The generator according to any one of claims 1-8, wherein the combustion chamber comprises an increasing outlet diameter at the aperture end thereof.

10. The generator according to claim 9, wherein the increased outlet diameter comprises an extension having a cone shape, which is connected to or formed with said combustion chamber.

11. The generator according to any one of claims 1-10 further comprising a control unit configured to control the mixer and/or igniter.

12. The generator according to any one of claims 1-11 for use as a non-lethal means for the deterrence of mammals, poultry and fish.

13. A multi-barrel shock wave generator, configured to generate a synchronized controlled wave front, said generator comprising:
a supply line having a nozzle, said supply line is configured to receive a combustive fluid;
an igniter provided in said supply line, said igniter is configured to initiate a flame front and cause detonation in a combustion chamber; wherein the combustion chamber is associated with said nozzle, and is configured to receive said combustive fluid from said nozzle, said combustion chamber comprises:
an aperture opposite said nozzle, and turbulence stimulator unit, said turbulence stimulator unit comprises a pole located along the internal cavity of said combustion chamber, said pole is provided with a plurality of lateral protrusion units configured to encounter the flame front, wherein said plurality of lateral protrusion units are arranged on said pole in at least three portions, wherein the first portion is adjacent said nozzle and wherein each consequent portion is provided with protrusion units comprising additional encountering protrusion elements compared to the number of encountering protrusion elements in the respective protrusion units in a former portion; and two or more exit barrels, associated with the aperture of the combustion chamber;
whereby, a periodically initiated flame front generated detonation is controlled by said plurality of lateral protrusion units, and is propagating from said nozzle to said aperture, to synchronically propagate and exit thought the exit barrels.

14. The multi-barrel generator according to claim 13, wherein the lateral protrusion units in said, attached along said pole.

15. The multi-barrel generator according to any one of claims 13-14, wherein each of the barrels comprises an increasing outlet diameter at the exit end thereof.

16. The multi-barrel generator according to any one of claims 13-15 for use as a non-lethal means for the deterrence of mammals, poultry and fish.

17. A method of generating a shock wave, said method comprising
providing a shock wave generator comprising:
a supply line having a nozzle, said supply line is configured to receive a combustive fluid;
an igniter provided in said supply line, said igniter is configured to initiate a flame front and cause detonation in a combustion chamber; wherein the combustion chamber is associated with said nozzle, and is configured to receive said combustive fluid from said nozzle, said combustion chamber comprises:
an aperture opposite said nozzle, and turbulence stimulator unit, said turbulence stimulator unit comprises a pole located along the internal cavity of said combustion chamber, said pole is provided with a plurality of lateral protrusion units configured to encounter the flame front, wherein said plurality of lateral protrusion units are arranged on said pole in at least three portions, wherein the first portion is adjacent said nozzle and wherein each consequent portion is provided with protrusion units comprising additional encountering protrusion elements compared to the number of encountering protrusion elements in the respective protrusion units in a former portion;
providing combustive fluid through said supply line to said combustion chamber; and
ignite said combustive fluid using said igniter.

18. A method of generating a synchronized shock wave, using a multi-barrel shock wave generator said method comprising
providing a multi-barrel shock wave generator comprising:
a supply line having a nozzle, said supply line is configured to receive a combustive fluid;
an igniter provided in said supply line, said igniter is configured to initiate a flame front and cause detonation in a combustion chamber; wherein the combustion chamber is associated with said nozzle, and is configured to receive said combustive fluid from said nozzle, said combustion chamber comprises:
an aperture opposite said nozzle, and turbulence stimulator unit, said turbulence stimulator unit comprises a pole located along the internal cavity of said combustion chamber, said pole is provided with a plurality of lateral protrusion units configured to encounter the flame front, wherein said plurality of lateral protrusion units are arranged on said pole in at least three portions, wherein the first portion is adjacent said nozzle and wherein each consequent portion is provided with protrusion units comprising additional encountering protrusion elements compared to the number of encountering protrusion elements in the respective protrusion units in a former portion; and
two or more exit barrels, associated with the aperture of the combustion chamber;
providing combustive fluid through said supply line to said combustion chamber; and
ignite said combustive fluid using said igniter.
